(19) United States
(12) Patent Application Publication
(10) Pub. No.: US 2025/0077980 A1
(43) Pub. Date: Mar. 6, 2025

(54) METHOD, APPARATUS, DEVICE, AND STORAGE MEDIUM FOR MODEL TRAINING

(71) Applicants: Lemon Inc., Grand Cayman (KY); Beijing Youzhuju Network Technology Co., Ltd., Beijing (CN)

(72) Inventors: Xinbo ZHANG, Beijing (JP); Luong Quoc TRUNG, Singapore (SG); Zhanming JIE, Singapore (SG); Peng SUN, Beijing (CN); Xiaoran JIN, JR., Beijing (CN); Hang LI, Beijing (CN)

(21) Appl. No.: 18/952,687

(22) Filed: Nov. 19, 2024

(30) Foreign Application Priority Data
Jan. 15, 2024 (CN) 202410060894.7

(51) Int. Cl. G06N 20/00

(52) U.S. Cl. CPC G06N 20/00

(57) ABSTRACT

There are provided a method, an apparatus, a device, and a storage medium for model training. In a method, a target model is fine-tuned using a set of training data, each training data including a sample question and corresponding annotation information, the annotation information including policy information for solving the sample question and answer information of the sample question. At least one sample question in the set of training data is provided to the fine-tuned target model to determine a candidate answer to the at least one sample question. The fine-tuned target model is trained based at least on a comparison between the candidate answer and the answer information of the at least one sample question.

### CROSS-REFERENCE

The present application claims priority to Chinese Patent Application No. 202410060894.7, filed on Jan. 15, 2024 and entitled “METHOD, APPARATUS, DEVICE, AND STORAGE MEDIUM FOR MODEL TRAINING”, the entirety of which is incorporated herein by reference.

### FIELD

Example embodiments of the present disclosure generally relate to the field of computers, and in particular to a method, an apparatus, a device, and a computer-readable storage medium for model training.

### BACKGROUND

With the development of computer technologies, various models are gradually applied to various aspects of people's daily lives. For example, some models may, for example, perform solving of problems in specific fields. For example, taking a mathematics question as an example, some models may provide a solving process for such a mathematics question.

### SUMMARY

In a first aspect of the present disclosure, a method of model training is provided. The method comprises: fine-tuning a target model using a set of training data, each training data comprising a sample question and corresponding annotation information, the annotation information comprising policy information for solving the sample question and answer information of the sample question; providing at least one sample question in the set of training data to the fine-tuned target model to determine a candidate answer to the at least one sample question; and training the fine-tuned target model based at least on a comparison between the candidate answer and the answer information of the at least one sample question.

In a second aspect of the present disclosure, an apparatus for model training is provide. The apparatus comprises: a fine-tuning module configured to fine-tune a target model using a set of training data, each training data comprising a sample question and corresponding annotation information, the annotation information comprising policy information for solving the sample question and answer information of the sample question; a sampling module configured to provide at least one sample question in the set of training data to the fine-tuned target model to determine a candidate answer to the at least one sample question; and a training module configured to train the fine-tuned target model based at least on a comparison between the candidate answer and the answer information of the at least one sample question.

In a third aspect of the present disclosure, an electronic device is provided. The device comprises: at least one processing unit; and at least one memory coupled to the at least one processing unit and storing instructions executable by the at least one processing unit. The instructions, when executed by the at least one processing unit, causes the device to perform the method according to the first aspect.

In a fourth aspect of the present disclosure, a computer-readable storage medium is provided. The computer-readable storage medium has a computer program stored thereon, and the computer program is executable by a processor to implement the method according to the first aspect.

It should be understood that the content described in this Summary section is not intended to limit the key or important features of the embodiments of the present disclosure, nor is it intended to limit the scope of the present disclosure. Other features of the present disclosure will become readily comprehensible through the following description.

### BRIEF DESCRIPTION OF THE DRAWINGS

The above and other features, advantages and aspects of embodiments of the present disclosure will become more apparent with reference to the following detailed description in conjunction with the accompanying drawings. In the drawings, the same or similar reference signs denote the same or similar elements, where:

FIGS. 1A and 1B show an example process of training a model according to a traditional solution;

FIG. 2 shows a flowchart of an example model training process according to some embodiments of the present disclosure;

FIG. 3 shows a block diagram of an example model training system according to some embodiments of the present disclosure;

FIG. 4 shows a schematic structure block diagram of an example apparatus for model training according to some embodiments of the present disclosure; and

FIG. 5 shows a block diagram of an electronic device capable of implementing multiple embodiments of the present disclosure.

### DETAILED DESCRIPTION

Embodiments of the present disclosure will be described in more detail below with reference to the accompanying drawings. Although some embodiments of the present disclosure are shown in the drawings, it should be understood that the present disclosure can be implemented in various forms and should not be construed as being limited to the embodiments set forth herein. Rather, these embodiments are provided for a more thorough and complete understanding of the present disclosure. It should be understood that the drawings and embodiments of the present disclosure are only for exemplary purposes, and are not intended to limit the scope of protection of the present disclosure.

It should be noted that the title of any section/subsection provided herein is not restrictive. Various embodiments are described throughout the present specification, and any type of embodiment may be included under any section/subsection. In addition, embodiments described in any section/subsection may be combined in any way with any other embodiments described in the same section/subsection and/or in different sections/subsections.

In the description of the embodiments of the present disclosure, the term “including” and similar terms should be understood as open inclusion, that is, “including but not limited to”. The term “based on” should be understood as “at least partially based on”. The term “an embodiment” or “the embodiment” should be understood as “at least one embodiment”. The term “some embodiments” should be understood as “at least some embodiments”. Other explicit and implicit definitions may also be included below. The terms “first”, “second”, etc. may refer to different or the same objects. Other explicit and implicit definitions may also be included below.

The embodiments of the present disclosure may involve user data, data acquisition and/or use, etc. These aspects all follow the corresponding laws, regulations and related provisions. In the embodiments of the present disclosure, all data collection, acquisition, processing, fabricating, forwarding, use, etc. are carried out on the premise that the user knows and confirms. Accordingly, when implementing each embodiment of the present disclosure, the user should be informed of the type, scope of use, use scenario, etc. of data or information that may be involved through appropriate means in accordance with relevant laws and regulations and obtain the user's authorization. The specific notification and/or authorization method may vary according to the actual situation and application scenarios, and the scope of the present disclosure is not limited in this regard.

The solutions in the present specification and the embodiments, if involving personal information processing, will be processed on the premise of having a legal basis (such as obtaining the consent of the subject of personal information or being necessary for performing a contract, etc.), and will only be processed within the scope of the regulations or agreements. If the user refuses to process personal information other than necessary information required for basic functions, the user's use of basic functions will not be affected.

As briefly mentioned above, with the development of computer technologies, various models are gradually applied to various aspects of people's daily lives. For example, some models may, for example, perform solving of problems in specific fields. For example, taking a mathematics question as an example, some models may provide a solving process for such a mathematics question.

However, the traditional model training process relies on a large amount of annotated data to determine the solving process of the problem. However, some problems may have a plurality of different solving policies, and the traditional training process will make the model unable to effectively expand the solving policies other than the annotated data, which greatly affects the scalability of the model.

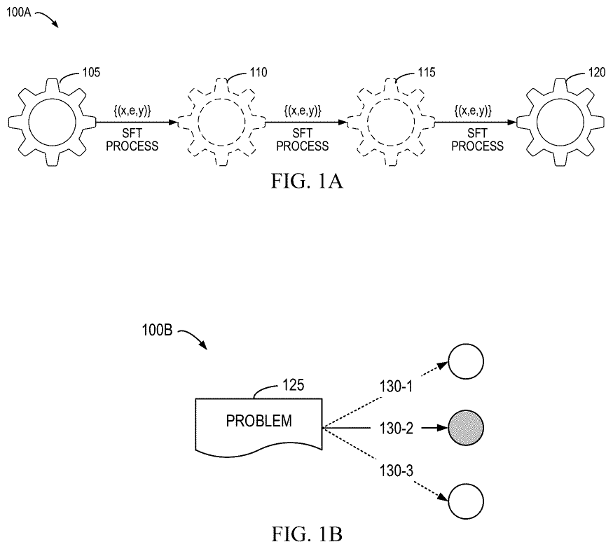

FIGS. 1A and 1B show schematic diagrams 100A and 100B of training a model according to a traditional solution. As shown in FIG. 1A, in the process of training the model, the model may be fine-tuned by performing multiple rounds of supervised fine-tuning (SFT) processes. For example, the initial model 105 may be fine-tuned to the model 110, the model 115, and the final model 120 in sequence in multiple rounds of SFT fine-tuning processes.

For example, the model may be fine-tuned using the training data {(x, e, y)}, where x represents a sample question, e represents policy information for solving the sample question, for example, Chain-of-Thought (CoT), and y represents answer information of the sample question.

However, as shown in FIG. 1B, when the model 120 is used to solve the problem 125, the model 120 will be limited by the policy information annotated in the training data. For example, the model 120 may only provide the annotated CoT 130-2 in the training data to solve the problem 125, and it is difficult to expand other possible CoTs that can solve the problem 125, for example, the CoT 130-1 or the CoT 130-3.

Embodiments of the present disclosure propose a solution for model training. According to the solution, a target model is fine-tuned using a set of training data, each training data comprises a sample question and corresponding annotation information, the annotation information comprises policy information for solving the sample question and answer information of the sample question. At least one sample question in the set of training data is provided to the fine-tuned target model to determine a candidate answer to the at least one sample question. Further, the fine-tuned target model is trained based at least on a comparison between the candidate answer and the answer information of the at least one sample question.

In this way, the embodiments of the present disclosure can use the same training dataset to perform the fine-tuning and reinforcement learning processes on the model, so that the model can expand other policies different from the annotated data, thereby improving the scalability of the model.

The various example implementations of the solution are described in further detail below in conjunction with the accompanying drawings.

### Example Training Process

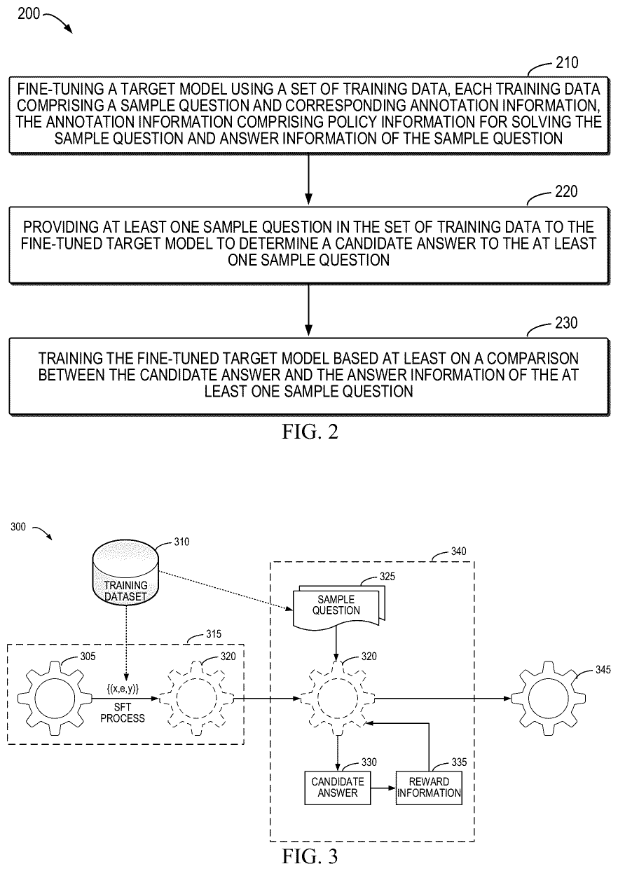

A model training process according to some embodiments of the present disclosure will be described below with reference to FIGS. 2 and 3. FIG. 2 shows a flowchart of an example process 200 for model training according to some embodiments of the present disclosure. FIG. 3 shows a schematic diagram of an example training system 300 according to some embodiments of the present disclosure. The process 200 may be implemented, for example, at the training system 300.

As shown in FIG. 2, at block 210, the training system 300 fine-tunes a target model using a set of training data, wherein each training data comprises a sample question and corresponding annotation information, the annotation information comprises policy information for solving the sample question and answer information of the sample question.

As shown in FIG. 3, the training system 300 may fine-tune the target model 305 using a set of training data in the training dataset 310 at the first stage 315. In some examples, the first stage 315 may also be referred to as a “warm-up stage”.

In some embodiments, the training data included in the training dataset 310 may be represented as {(x, e, y)} to fine-tune the model, where x represents a sample question, and e and y are annotation information corresponding to the sample question x. Specifically, e represents policy information for solving the sample question, for example, Chain-of-Thought (CoT); and y represents answer information of the sample question.

As an example, the training system 300 may use an SFT process to fine-tune the target model 305 to obtain the fine-tuned target model 320. In some embodiments, in order to retain the divergence capability of the target model 305, the training system 300 may perform a predetermined number of fine-tuning processes on the target model 305, where the predetermined number is less than a threshold. For example, the training system 300 may perform one or two rounds of SFT processes on the target model 305 to obtain the fine-tuned target model 320. At this time, the fine-tuned target model 320 has a relatively good divergence capability.

With continued reference to FIG. 2, at block 220, the training system 300 provides at least one sample question in the set of training data to the fine-tuned target model to determine a candidate answer to the at least one sample question.

As shown in FIG. 3, at the second stage 340, the training system 300 may continue to use the same training dataset 310 to perform reinforcement learning-based training on the fine-tuned target model 320. The second stage 340 may also be referred to as a reinforcement learning stage.

Specifically, the training system 300 may determine at least one sample question 325 from the training dataset 310. For example, the training system 300 may determine the at least one sample question 325 based on sampling of the set of training data in the training dataset 310. The at least one sample question 325 may also comprise a plurality of sample questions, and constitute a set of sample questions for adjusting model parameters.

Further, the training system 300 may provide the at least one sample question 325 to the fine-tuned target model 320 to determine a corresponding candidate answer 330. Specifically, the fine-tuned target model 320 may process the received at least one sample question 325 to determine candidate policy and a corresponding candidate answer 330 for solving the at least one sample question 325.

With continued reference to FIG. 2, at block 230, the training system 300 trains the fine-tuned target model based at least on a comparison between the candidate answer and the answer information of the at least one sample question.

Specifically, as shown in FIG. 3, the training system 300 may determine reward information 335 based on a comparison between the candidate answer 330 and the answer information annotated in the training dataset 310 and corresponding to the sample question 325, and may train the fine-tuned target model 320 using the reward information 335.

Specifically, the training system 330 may determine a first reward part based on the comparison between the candidate answer 330 and the answer information annotated in the training dataset 310 and corresponding to the sample question 325. This process may be expressed as:

$$r ( {s}_{t} , {a}_{t} , {s}_{t + 1} ) = \{ \begin{matrix}1 , & EXTRACT ( {s}_{t + 1} ) = y \\ 0.1 , & EXTRACT ( {s}_{t + 1} ) \neq null , \neq y \\ 0 , & EXTRACT ( {s}_{t + 1} ) = null\end{matrix} \qquad ( 1 )$$

$${s}_{t + 1} = \{ \begin{matrix}{x}_{t} & t = 0 \\ [ {s}_{t} , {a}_{t} ] , & 1 \leq t \leq L\end{matrix} \qquad ( 2 )$$

$$e = [ {a}_{1} , {a}_{2} , … , {a}_{L - 1} , {a}_{L} = 〈 eos 〉 ] \qquad ( 3 )$$

where L represents the maximum length, at represents an action at the moment t, <eos> represents the end of the CoT generation process, and the state sₜ includes all tokens in the question x and tokens in the generated CoT; EXTRACT (Sₜ₊₁) represents the candidate answer generated by the target model in the reinforcement learning process.

It can be seen from Equation (1) that the training system 300 may determine the first reward part according to three different situations. Specifically, in a case that the candidate answer matches the answer information y, the training system 300 may determine the first reward part as a first value (for example, 1). In a case that the candidate answer output by the target model is not null and the candidate answer does not match the answer information y, the training system 300 may determine the first reward part as a second value (for example, 0.1). In some examples, the second value may, for example, be much smaller than the first value.

In addition, in a case that the candidate answer output by the target model is null, the training system 300 may determine the first reward part as a third value (for example, 0).

Alternatively, in a case that the candidate answer output by the target model is not null and the candidate answer does not match the answer information y, the training system 300 may, for example, also set its reward information to the third value (for example, 0).

In this way, the embodiments of the present disclosure may use the matching between the candidate answer and the answer information to perform the reinforcement learning process of the model, thereby increasing the divergence degree of the model regarding the policy information.

In some embodiments, in addition to the first reward part, the training system 300 may further determine second reward information based on a change in the candidate policy determined by the target model. Specifically, the reward information 335 may be expressed as:

$${r}_{total} ( {s}_{t} , {a}_{t} , {s}_{t + 1} ) = r ( {s}_{t} , {a}_{t} , {s}_{t + 1} ) - β KL ( {π}_{θ} ( \cdot \vert {s}_{t} ) , {π}_{θ}^{( 0 )} ( \cdot \vert {s}_{t} ) ) \qquad ( 4 )$$

where KL ( ) represents KL divergence calculation, B represents a weight coefficient, π_{θ} (·|Sₜ) represents the candidate policy determined by the target model in the reinforcement learning process, and π_{θ}⁽⁰⁾ (·|Sₜ) represents the candidate policy output by the fine-tuned target model (before the reinforcement learning process starts).

Accordingly, the training system 300 may determine a second reward part based on a comparison between the candidate policy information π_{θ} (·|Sₜ) determined by the fine-tuned target model for the at least one sample question and reference policy information π_{θ}⁽⁰⁾(·|Sₜ).

In some embodiments, in the training process, the training system 300 may maximize the reward information 335. That is, the training system 300 may maximize the first reward part and minimize the second reward part. In this way, the training system 300 may make the output answer match the annotated answer information while keeping the policy information from changing too much.

In some embodiments, in order to improve the efficiency of reinforcement learning, the training system 300 may also use a Proximal Policy Optimization (PPO) process to perform the training in the second stage 340 to determine the final target model 345.

Specifically, the training system 300 may determine the advantage information in reinforcement learning based on the following process:

$${A}_{t} = {\sum }_{l = 0}^{L - t} {( γ λ )}^{l} {δ}_{t + l} \qquad ( 5 )$$

$${δ}_{{t}^{′}} = - {V}_{ϕ} ( {s}_{{t}^{′}} ) + {r}_{total} ( {s}_{{t}^{′}} , {a}_{{t}^{′}} , {s}_{{t}^{′} + 1} ) + γ {V}_{ϕ} ( {s}_{{t}^{′} + 1} ) \qquad ( 6 )$$

where λ is the depreciation factor of the reward information, and γ is the depreciation factor of the temporal difference (TD) as defined in Equation (6).

Further, the estimated value of the return may be expressed as:

$${\hat{R}}_{t} = {\hat{A}}_{t} + {V}_{ϕ} ( {s}_{t} ) \qquad ( 7 )$$

Accordingly, the training loss in the reinforcement learning process may be expressed as:

$${ℒ}_{RL} ( θ , ϕ ) = {ℒ}_{policy} + {αℒ}_{value} \qquad ( 8 )$$

where α represents the weight coefficient, and

$${ℒ}_{policy} ( θ ) = - 𝔼 \text{?} [ min ( \frac{{π}_{θ} ( {a}_{t} \vert {s}_{t} )}{π \text{?} ( {a}_{t} \vert {s}_{t} )} {\hat{A}}_{t} , clip ( \frac{{π}_{θ} ( {a}_{t} \vert {s}_{t} )}{π \text{?} ( {a}_{t} \vert {s}_{t} )} , 1 - ϵ , 1 + ϵ ) {\hat{A}}_{t} ) ] \qquad ( 9 )$$

$${ℒ}_{value} ( θ ) = \frac{1}{2} 𝔼 \text{?} [ max ( {‖ {V}_{ϕ} ( {s}_{t} ) - {\hat{R}}_{t} ‖}^{2} , {‖ clip ( {V}_{ϕ} ( {s}_{t} ) - {\hat{R}}_{t} , {\hat{A}}_{t} - ϵ , {\hat{A}}_{t} + ϵ ) ‖}^{2} ) ] \qquad ( 10 )$$

$$\text{?} \text{indicates text missing or illegible when filed}$$

Where: πθ_{old}, V_{Φ}_{_{old}} is used to sample the CoT and calculate Âₜ, \hat{R}ₜ.

In some embodiments, the training system 300 may further provide the trained target model 345 for processing a received target question. For example, the target model 345 may provide an answer to the received target question.

In some embodiments, the sample question and/or the target question processed by the target model mentioned above may include any type of appropriate question, and such an appropriate question may, for example, have a corresponding standard answer. Such a standard answer may, for example, be in an appropriate form such as a single value, multiple values, a value range, etc.

In some embodiments, such a sample question or target question may, for example, include a mathematics question. The target model may provide a solution to the mathematics question based on the above training process. In some embodiments, such a sample question may, for example, also include other types of logical reasoning questions, such as questions regarding understanding of text content or image content, etc.

Based on the process described above, the embodiments of the present disclosure may use the same training dataset to perform the fine-tuning and reinforcement learning processes on the model, so that the model can expand other policies different from the annotated data, thereby improving the scalability of the model.

### Example Apparatus and Device

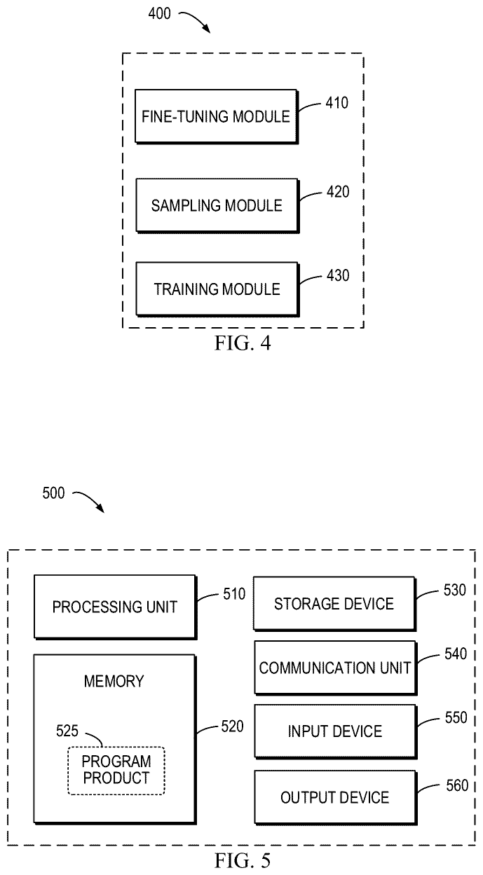

Embodiments of the present disclosure further provide a corresponding apparatus for implementing the above method or process. FIG. 4 shows a schematic structure block diagram of an example apparatus 400 for model training according to some embodiments of the present disclosure. The apparatus 400 may be implemented as or included in the training system 300. Each module/component in the apparatus 400 may be implemented by hardware, software, firmware, or any combination thereof.

As shown in FIG. 4, the apparatus 400 comprises: a fine-tuning module 410 configured to fine-tune a target model using a set of training data, each training data comprising a sample question and corresponding annotation information, the annotation information comprising policy information for solving the sample question and answer information of the sample question; a sampling module 420 configured to provide at least one sample question in the set of training data to the fine-tuned target model to determine a candidate answer to the at least one sample question; and a training module 430 configured to train the fine-tuned target model based at least on a comparison between the candidate answer and the answer information of the at least one sample question.

In some embodiments, the fine-tuning module 410 is further configured to: perform a predetermined number of fine-tuning processes on the target model using the set of data, wherein the predetermined number is less than a threshold.

In some embodiments, the training module 430 is further configured to: determine reward information based on the comparison between the candidate answer and the answer information of the at least one sample question; and train the fine-tuned target model based on the reward information.

In some embodiments, the training module 430 is further configured to: in response to the candidate answer matching the answer information, determine the reward information based on a first value; in response to the candidate answer not being null and matching the answer information, determine the reward information based on a second value; or in response to the candidate answer being null, determine the reward information based on a third value.

In some embodiments, the training module 430 is further configured to: determine a first reward part based on the comparison between the candidate answer and the answer information of the at least one sample question; determine a second reward part based on a comparison between candidate policy information determined by the fine-tuned target model for the at least one sample question and reference policy information; and determine the reward information based on the first reward part and the second reward part.

In some embodiments, the reference policy information comprises: policy information determined by the fine-tuned target model before training using the reward information.

In some embodiments, the training module 430 is further configured to: train the fine-tuned target model by maximizing the first reward part of the reward information and minimizing the second reward part of the reward information.

In some embodiments, the apparatus 400 further comprises a question determining module configured to: determine the at least one sample question based on sampling of the set of training data.

In some embodiments, the training module 430 is further configured to: train the fine-tuned target model based on a proximal policy optimization process.

In some embodiments, the apparatus 400 further comprises a providing module configured to: provide the trained target model for providing an answer to a received target question.

In some embodiments, the sample question comprises a mathematics question.

FIG. 5 shows a block diagram of an electronic device 500 in which one or more embodiments of the present disclosure may be implemented. It should be understood that the electronic device 500 shown in FIG. 5 is merely exemplary, and should not constitute any limitation on the function and scope of the embodiments described herein. The electronic device 500 shown in FIG. 5 may be used to implement the training system 300 of FIG. 3.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be a physical or virtual processor and can perform various processes according to a program stored in the memory 520. In a multi-processor system, multiple processing units execute computer-executable instructions in parallel to improve the parallel processing capability of the electronic device 500.

The electronic device 500 typically comprises a plurality of computer storage media. Such media may be any available media accessible by the electronic device 500, including but not limited to volatile and non-volatile media, removable and non-removable media. The memory 520 may be a volatile memory (e.g., a register, cache, random access memory (RAM)), a non-volatile memory (e.g., a read-only memory (ROM), electrically erasable programmable read-only memory (EEPROM), flash memory), or some combination thereof. The storage device 530 may be a removable or non-removable medium, and may include machine-readable media such as a flash drive, a disk, or any other medium, which may be used to store information and/or data and may be accessed within the electronic device 500.

The electronic device 500 may further include additional removable/non-removable, volatile/non-volatile storage media. Although not shown in FIG. 5, a disk drive for reading from or writing to a removable, non-volatile disk (e.g., “floppy disk”), and an optical disk drive for reading from or writing to a removable, non-volatile optical disk may be provided. In these cases, each drive may be connected to a bus (not shown) via one or more data medium interfaces. The memory 520 may include a computer program product 525 having one or more program modules configured to perform various methods or actions of various embodiments of the present disclosure.

The communication unit 540 enables communication with other electronic devices through a communication medium. Additionally, the functions of the components of the electronic device 500 may be implemented by a single computing cluster or multiple computing machines, which can communicate through communication connections. Therefore, the electronic device 500 may operate in a networked environment using logical connections with one or more other servers, network personal computers (PCs), or another network node.

The input device 550 may be one or more input devices, such as a mouse, a keyboard, a trackball, etc. The output device 560 may be one or more output devices, such as a display, a speaker, a printer, etc. The electronic device 500 may also communicate with one or more external devices (not shown) as needed through the communication unit 540, such as a storage device, a display device, etc., with one or more devices that enable users to interact with the electronic device 500, or with any device that enables the electronic device 500 to communicate with one or more other electronic devices (e.g., a network card, a modem, etc.). Such communication may be performed via an input/output (I/O) interface (not shown).

According to an example implementation of the present disclosure, there is provided a computer-readable storage medium having computer-executable instructions stored thereon, wherein the computer-executable instructions are executed by a processor to implement the method described above. According to an example implementation of the present disclosure, there is further provided a computer program product, the computer program product being tangibly stored on a non-transitory computer-readable medium and including computer-executable instructions, and the computer-executable instructions being executed by the processor to implement the method described above.

Various aspects of the present disclosure are described herein with reference to flowcharts and/or block diagrams of methods, apparatus, devices and computer program products implemented according to the present disclosure. It should be understood that each block of the flowcharts and/or block diagrams, and combinations of blocks in the flowcharts and/or block diagrams, can be implemented by computer-readable program instructions.

These computer-readable program instructions may be provided to a processing unit of a general-purpose computer, special-purpose computer, or other programmable data processing apparatus to produce a machine, such that the instructions, when executed by the processing unit of the computer or other programmable data processing apparatus, create means for implementing the functions/actions specified in one or more blocks in the flowcharts and/or block diagrams. These computer-readable program instructions may also be stored in a computer-readable storage medium, which instructions cause a computer, a programmable data processing apparatus, and/or other devices to work in a specific manner, such that the computer-readable medium storing the instructions includes a manufacture article that includes instructions that implement various aspects of the functions/actions specified in one or more blocks in the flowcharts and/or block diagrams.

The computer-readable program instructions may be loaded onto a computer, other programmable data processing apparatus, or other device, such that a series of operational steps are performed on the computer, other programmable data processing apparatus, or other device to produce a computer-implemented process, such that the instructions executed on the computer, other programmable data processing apparatus, or other device implement the functions/actions specified in one or more blocks in the flowcharts and/or block diagrams.

The flowcharts and block diagrams in the accompanying drawings show the possibly implemented architecture, functions, and operations of the system, method, and computer program product according to various implementations of the present disclosure. In this regard, each block in the flowchart or block diagram may represent a module, program segment, or part of instructions, and the module, program segment, or part of instructions contains one or more executable instructions for implementing the specified logical functions. In some alternative implementations, the functions marked in the blocks may also occur in an order different from that marked in the accompanying drawings. For example, two blocks shown in succession may actually be executed substantially in parallel, or they may sometimes be executed in the reverse order, depending on the functions involved. It should also be noted that each block in the block diagram and/or flowchart, and combinations of blocks in the block diagram and/or flowchart, may be implemented by a dedicated hardware-based system that executes specified functions or actions, or may be implemented by a combination of dedicated hardware and computer instructions.

The various implementations of the present disclosure have been described above. The above description is exemplary, not exhaustive, and is not limited to the disclosed implementations. Many modifications and changes are obvious to those of ordinary skill in the art without departing from the scope and spirit of the described implementations. The selection of terms used herein is intended to best explain the principles of the implementations, the practical application or the improvement to the technology in the market, or to enable other ordinary skilled in the art to understand the various implementations disclosed herein.

I/We claim:

1. A method of model training, comprising:
fine-tuning a target model using a set of training data, each training data comprising a sample question and corresponding annotation information, the annotation information comprising policy information for solving the sample question and answer information of the sample question;
providing at least one sample question in the set of training data to the fine-tuned target model to determine a candidate answer to the at least one sample question; and
training the fine-tuned target model based at least on a comparison between the candidate answer and the answer information of the at least one sample question.

2. The method according to claim 1, wherein fine-tuning the target model using the set of training data comprises:
performing a predetermined number of fine-tuning processes on the target model using the set of training data, wherein the predetermined number is less than a threshold.

3. The method according to claim 1, wherein training the fine-tuned target model based at least on the comparison between the candidate answer and the answer information of the at least one sample question comprises:
determining reward information based on the comparison between the candidate answer and the answer information of the at least one sample question; and
training the fine-tuned target model based on the reward information.

4. The method according to claim 3, wherein determining the reward information comprises:
in response to the candidate answer matching the answer information, determining the reward information based on a first value;
in response to the candidate answer not being null and matching the answer information, determining the reward information based on a second value; or
in response to the candidate answer being null, determining the reward information based on a third value.

5. The method according to claim 3, wherein determining the reward information based on the comparison between the candidate answer and the answer information of the at least one sample question comprises:
determining a first reward part based on the comparison between the candidate answer and the answer information of the at least one sample question;
determining a second reward part based on a comparison between candidate policy information determined by the fine-tuned target model for the at least one sample question and reference policy information; and
determining the reward information based on the first reward part and the second reward part.

6. The method according to claim 5, wherein the reference policy information comprises: policy information determined by the fine-tuned target model before the training using the reward information.

7. The method according to claim 5, wherein training the fine-tuned target model comprises:
training the fine-tuned target model by maximizing the first reward part of the reward information and minimizing the second reward part of the reward information.

8. The method according to claim 1, further comprising:
determining the at least one sample question based on sampling of the set of training data.

9. The method according to claim 1, wherein training the fine-tuned target model comprises:
training the fine-tuned target model based on a proximal policy optimization process.

10. The method according to claim 1, further comprising:
providing the trained target model for providing an answer to a received target question.

11. The method according to claim 1, wherein the sample question comprises a mathematics question.

12. An electronic device, comprising:
at least one processing unit; and
at least one memory coupled to the at least one processing unit and storing instructions executable by the at least one processing unit, the instructions, when executed by the at least one processing unit, causing the electronic device to perform acts comprising:
fine-tuning a target model using a set of training data, each training data comprising a sample question and corresponding annotation information, the annotation information comprising policy information for solving the sample question and answer information of the sample question;
providing at least one sample question in the set of training data to the fine-tuned target model to determine a candidate answer to the at least one sample question; and
training the fine-tuned target model based at least on a comparison between the candidate answer and the answer information of the at least one sample question.

13. The electronic device according to claim 12, wherein fine-tuning the target model using the set of training data comprises:
performing a predetermined number of fine-tuning processes on the target model using the set of training data, wherein the predetermined number is less than a threshold.

14. The electronic device according to claim 12, wherein training the fine-tuned target model based at least on the comparison between the candidate answer and the answer information of the at least one sample question comprises:
determining reward information based on the comparison between the candidate answer and the answer information of the at least one sample question; and
training the fine-tuned target model based on the reward information.

15. The electronic device according to claim 14, wherein determining the reward information comprises:
in response to the candidate answer matching the answer information, determining the reward information based on a first value;
in response to the candidate answer not being null and matching the answer information, determining the reward information based on a second value; or
in response to the candidate answer being null, determining the reward information based on a third value.

16. The electronic device according to claim 14, wherein determining the reward information based on the comparison between the candidate answer and the answer information of the at least one sample question comprises:
determining a first reward part based on the comparison between the candidate answer and the answer information of the at least one sample question;
determining a second reward part based on a comparison between candidate policy information determined by the fine-tuned target model for the at least one sample question and reference policy information; and
determining the reward information based on the first reward part and the second reward part.

17. The electronic device according to claim 16, wherein the reference policy information comprises: policy information determined by the fine-tuned target model before the training using the reward information.

18. The electronic device according to claim 16, wherein training the fine-tuned target model comprises:
training the fine-tuned target model by maximizing the first reward part of the reward information and minimizing the second reward part of the reward information.

19. The electronic device according to claim 12, further comprising:
determining the at least one sample question based on sampling of the set of training data.

20. A non-transitory computer-readable storage medium having a computer program stored thereon, the computer program being executable by a processor to implement a method comprising:
fine-tuning a target model using a set of training data, each training data comprising a sample question and corresponding annotation information, the annotation information comprising policy information for solving the sample question and answer information of the sample question;
providing at least one sample question in the set of training data to the fine-tuned target model to determine a candidate answer to the at least one sample question; and
training the fine-tuned target model based at least on a comparison between the candidate answer and the answer information of the at least one sample question.
